(19) United States
(12) Patent Application Publication
(10) Pub. No.: US 2011/0283593 A1
(43) Pub. Date: Nov. 24, 2011

(54) Surf Casting Device

(76) Inventor: Donald P. Parkinson, III, Jacksonville, NC (US)

(21) Appl. No.: 12/783,544

(22) Filed: May 19, 2010

(51) Int. Cl. A01K 91/02

(52) U.S. Cl. 43/19

(57) ABSTRACT

A free-standing, cross-shaped tubular frame having a v-shaped top portion with two pair of elastic projection means disposed therein, a carrier affixed to the two pair of elastic projection means, the carrier adapted for retaining surf-fishing bait and rigging, the device adapted for pulling the carrier rearward and propelling the surf-fishing bait and rigging forward when the carrier is released.

### BACKGROUND OF THE INVENTION

1. Field of Invention

This invention relates generally to surf fishing devices and the like, and especially devices adapted to cast surf-fishing baits, lures and weights.

2. Description of the Prior Art

Surf Fishing is a sport enjoyed by many in coastal areas. Surf fishing typically involves use of a long, generally stiff fishing rod to cast weighted lures or bait into the ocean surf. While the skill of casting can be learned, there are those that cannot adequately enjoy sport fishing. For example, those with disabilities or infirmities can have difficulty in properly casting a surf-fishing rod. Casting can also be difficult. A well-performed surf cast may place bait about 100 feet out. However, larger fish are often found several hundred feet out past sand bars and breakers. Fishermen often wade out before casting to take advantage of the additional distance.

No free-standing devices are available that facilitate casting with a wide variety of fishing rods while also retaining the rod during casting or afterwards. Presently, a participant must hold a rod or the device to operate available casting devices. This hindrance further reduces accessibility to those who may be unable to hold the rod and operate the device simultaneously. Nor are previous sling shot type devices suitable for the larger, heavier-weight surf-casting gear, which typically includes sinkers or weights, multiple baited hooks, and leaders, all of which can weigh several ounces.

Some devices utilize an explosive projectile to cast the bait. However, these devices can be loud or annoying to users. Likewise, some users may not wish to use devices utilizing explosives. Additionally, such devices require a new explosive charge for each use.

### SUMMARY OF THE INVENTION

The present invention is directed to a bait-casting device, and more specifically to a surf-fishing bait casting device. In a preferred embodiment of the invention, the device comprises free-standing, cross-shaped tubular frame having a v-shaped top portion with two pair of elastic projection means disposed therein, a carrier affixed to the two pair of elastic projection means, the carrier adapted for retaining surf-fishing bait and rigging, the device adapted for pulling the carrier rearward and propelling the surf-fishing bait and rigging forward when the carrier is released.

The invention and the various features of novelty that characterize the invention are pointed out in the specification and claims annexed to and forming a part of this disclosure. For a more complete understanding of the invention, its operating advantages and uses, reference should be made to the accompanying drawings and descriptive matter in which there is illustrated preferred embodiments of the invention.

### BRIEF DESCRIPTION OF THE DRAWINGS

FIG. 1 shows a front elevation view of a device according to an embodiment of the invention.

FIG. 2 shows a side elevation view of a device according to an embodiment of the invention having a rest position a′ and a second position a″ and a rod and reel for illustrative purposes.

### DETAILED DESCRIPTION OF THE INVENTION

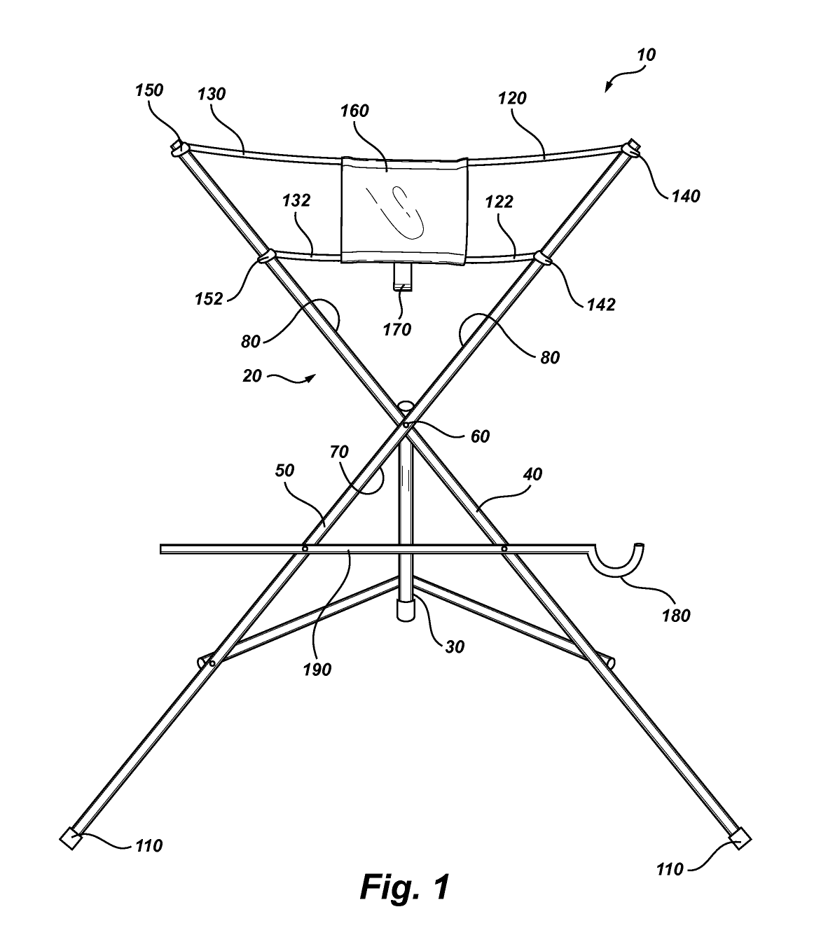

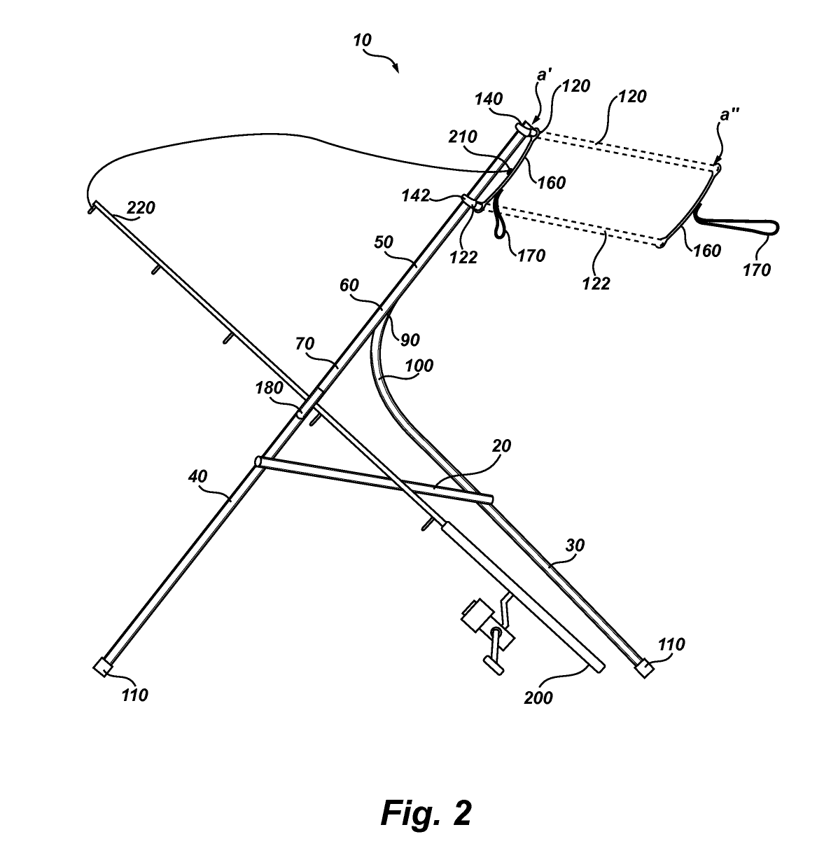

Referring now to the drawings in greater detail, FIG. 1 and FIG. 2 depict a surf-fishing casting device 10. In a preferred embodiment depicted, the device 10 comprises multiple tubular members generally arranged in cross-shaped or offset-“x” shaped frame 20 and a rearward offset stabilizing member. A first tubular member 40 connects to a second tubular member 50 at a point approximately two-thirds of each member's length. A connection portion 60, where the first and second tubular members 40, 50 connect, could vary along the length of the first tubular member 40 and the second tubular member 50 from half of their length to approximately one-third of their length. The first tubular member 40 and second tubular member 50 are offset about this connection such that a v-shaped bottom portion 70 and an opposite v-shaped top 80 portion is formed. The frame 20 is arranged such that the bottom portion 70 is dimensionally larger than the top portion 80 providing stability to the frame 20 during use. The connection may be made through any of a number of known connection means for securing tubular members such as tack welding, riveted, bolted, clamps, couplings and the like. The connection may be fixed or pivotal, allowing the first tubular member 40 and second tubular member 50 to be folded about the connection for ease in transport or storage. A third rear tubular member or stabilizing member 30 extends from the frame 20.

The rear tubular member 30 also has a connection portion 90 affixing to the connection. From this connection, the rear tubular member 30 extends downwardly and outwardly via a generally arcuate portion 100 that is bent or rolled to a predetermined radius. The roll radius ensures that the remainder of the rear tubular member 30 juts outwardly from the frame 20. The rear tubular member 30 has a predetermined length to preferably allow the frame 20 to lean backward at a preconfigured angle that may range from 1 degree to 45 degrees or more from the vertical axis. The tubular members 30, 40, 50 terminate in a cap or foot 110. A cap-style foot 110 would seal the end of the tube while other styles may be a protective plastic or rubber ring. Also, the foot 110 could be the exposed tube end that would permit the end portion of the tubular members 30, 40, 50 to be easily pushed into the sand for further stability during use. Tubular members 30, 40, 50 are preferably selected from light-weight metal such as aluminum, although a variety of metals having high strength to weight ratio's may be used. PVC and similar materials may also be utilized. Since the device 10 will be used in salt-water environments, aluminum is preferred to prevent rust and corrosion. The rear tubular member 30 may be configured to permanently affix to the frame 20 or detachably affix. If a detachable configuration is used, any of a variety of detachable affixing means well known in the mechanical arts may be utilized to detachably affix the rear tubular member 30 to the frame 20 at the point of connection along the connection portions 60, 90 such as bolted connections, pins, and the like. The rear tubular member 30 provides stability to the frame 20 and is preferably positioned so that the three feet 110 form an offset triangular base.

Two pair of elastic projection means affix to each of the first tubular member 40 and second tubular members 50 respectively. As depicted, each pair of elastic projection means is composed of a first elastic member 120, 130 and a second, longer, elastic member 122, 132. Elastic members 120, 122, 130, 132 are preferably composed of highly elastic, stretchable rubber compositions, surgical gum rubber bands and like elastic members. Elongated tubular elastic members commonly available and known in the art are preferably since they are strong, can be stretched significantly, and snap back to shape quickly providing a fast and effective propulsion means for the device 10. In one embodiment, each elastic member has a first end 140, 142 affixed to the frame 20 and an opposite second end affixed to a carrier 160. The elastic members are arranged such that the first elastic members 120, 122 are disposed on the frame 20 top portion 80 a predetermined distance from the frame 20 connection. The first elastic members 120, 122 are likewise disposed along the same horizontal plane relative to each other. The longer, second elastic members 130, 132 also have a first end 150, 152 affixed on the frame 20 top portion 80 distal the connection on the first tubular member 40 and second tubular member 50 respectively. The second elastic members 130, 132 are also disposed along the same horizontal plane relative to each other. The ends 140, 142, 150, 152 affixed to the frame 20 may be tied onto the frame 20, bolted to the frame 20, clamped to the frame 20, or otherwise affixed to the frame 20 using conventional means. The first elastic means and second elastic means on a tubular member forms the elastic projection means. The first elastic projection means and second elastic projection means affix to the carrier 160 as previously noted. The elastic projection means may be tied through grommets or holes disposed in the carrier 160. In this type of embodiment, carrier 160 has four corners with a grommet in each corner with each grommet further securing to one of the elastic members. The carrier 160 is preferably formed from a piece of flexible or pliable material such as canvas or other heavy fabric, rubber, leather, plastic or the like. Other carrier 160 choices also include rigid, pre-formed carrier 160 bodies such as a plastic cup or detent-shaped piece adapted for retaining a bait 210, sinkers, and line during use. In a preferred embodiment, the carrier 160 top portion and bottom portions are folded back on themselves allowing the elastic projection means to pass completely through the folded over portions, respectively. In this embodiment, the first elastic member 120 passes through the top portion fold and the second elastic member 130 passes through the bottom portion fold. A pull portion 170 is preferably affixed to the rear of the carrier 160 to facilitate grasping the carrier 160 during use. The pull portion 170 may be a canvas or cloth tab sewn or otherwise affixed to the carrier 160 using conventional means. The device 10 may also have a carrier 160 adapted to slidably receive the first and second elastic projection means there-through. In such embodiments, as depicted in FIG. 1, the carrier top and bottom may be folded over to and hemmed to form a conduit along the top and bottom carrier edges for receiving the first elastic projection means 120, 130 and the second elastic projection means 122, 132 therethrough. In such embodiments, the first elastic projection means 120, 130 is a continuous piece of elastic material while the second elastic projection means 122, 132 is likewise a continuous piece of elastic material. In this manner, the first and second elastic projection means retain the carrier in position.

The device 10 further includes a rod holder 180 for retaining a standard surf-fishing rod 200 during device 10 use. In a preferred embodiment, a downwardly disposed, u-shaped holder 180 formed into one end of a tubular cross-brace 190 disposed between the tubular members 40, 50 on the bottom portion retains the rod 200. The holder tubular cross-brace 190 extends outwardly from the frame so that the holder 180 is disposed outside of the frame, although other embodiments may include the holder 180 inside the frame at a predisposed point. The depicted holder 180 is generally hook-shaped such that a portion of the rod 200 can be placed inside the holder 180 while the rod 200 handle or grip is placed on the ground behind the device 10, all as shown in FIG. 2. This arrangement allows the tip 220 of the rod 200 to extend out in front of the frame 20.

To operate the device 10, a conventional rod 200 and reel assembly having baited 210 lines and sinkers is placed into the rod holder 180 as described. The leader having the sinker and baited 210 hooks are placed into the carrier 160 front or retention area. The carrier 160 is in a first position indicated by a′ in FIG. 2 during rest. The reel mechanism is opened so that line may draw from the reel. The user grasps the pull portion 170 and draws the carrier 160 backward to a second position indicated by a″ in FIG. 2, stretching the elastic members. When the carrier 160 is drawn backward the desired distance, the user releases the pull portion 170. The elastic members 120, 122, 130, 132 quickly return to their rest state forcefully moving the carrier 160 and retained bait 210 forward. The carrier 160 will continue forward some distance beyond the frame 20, then the elastic members will pull the carrier 160 backward until the carrier 160 is finally at the first position. The quick return of the carrier 160 to the first position a′ from the second position a″ forcefully casts the baited 210 line forward. The force provided by the elastic means casts the baited 210 line further than they would otherwise be cast using traditional casting means. In preferred embodiments, the device 10 may be quickly disassembled with the component members placed inside a pouch or bag for carrying. To facilitate breakdown, each tubular member may further be composed of a plurality of mating sections with each section having an end adapted for insertion into the mating end of the adjacent member.

While the preferred embodiment of the present invention has been described, additional variations and modifications in that embodiment may occur to those skilled in the art once they learn of the basic inventive concepts. Therefore, it is intended that the appended claims shall be construed to include both the preferred embodiment and all such variations and modifications as fall within the spirit and scope of the invention.

I claim:

1. A bait-casting fishing apparatus comprising:
a free-standing cross-shaped hollow tubular frame including a first tubular member connected to a second tubular member such that the members form a v-shaped bottom portion opposite a dimensionally smaller v-shaped top portion;
a rear tubular member stabilizing means extending downwardly and outwardly from the frame for stabilizing the frame during use;
a pair of elastic projection means, each pair of elastic projection means having a first end disposed on the first tubular member in spaced apart relation and a second end disposed on the second tubular member in spaced apart relation;
the pair of elastic projection means retaining a carrier disposed within the top portion between the first tubular member and second tubular member, the first elastic projection means adjacent the carrier top opposite the second elastic projection means adjacent the carrier bottom; the carrier further adapted to be drawn rearward;
the apparatus having a first position wherein the elastic projection means disposes the carrier within the top portion, and a second position wherein the carrier is pulled rearward extending the pairs of elastic projection means such that upon release of the carrier the pairs of elastic projection means propel the carrier forward to return to the first position.

2. The device according to claim 1 further wherein:
the carrier top slidably receives the first elastic projection means therethrough and the carrier bottom slidably receives the second elastic projection means therethrough.

3. The device according to claim 1 wherein:
a first pair of elastic projection means having first ends disposed on the first tubular member adjacent the top portion, a second pair of elastic projection means having first ends disposed on the second tubular member adjacent the top portion;
the first elastic projection means further comprises a first pair of elastic projection means, the second elastic projection means further comprises a second pair of elastic projection means, each pair of electric projection means having a first end affixed to the frame and a second end affixing to the carrier.

4. A method of casting a surf-fishing bait comprising:
resting a portion of a baited elongate fishing rod against a rest, the rest positioned on a free-standing cross-shaped hollow tubular frame having: a v-shaped bottom portion opposite a dimensionally smaller v-shaped top portion, and a rear tubular member stabilizing means extending downwardly and outwardly from the frame for stabilizing the frame during use;
the frame further having a first pair of elastic projection means having first ends affixed in spaced-apart relation on a first side of the v-shaped top portion, and a second pair of elastic projection means having first ends affixed in spaced-apart relation on a second side of the v-shaped top portion;
the first and second elastic projection means further having second ends affixing to a carrier in spaced apart relation such that the carrier is disposed within the top portion; the carrier having the bait disposed therein;
drawing the carrier from a first position to a second position rearward at least a predetermined distance thereby elongating the elastic projection means;
releasing the carrier such that the elastic projection means return the carrier to the first position, forcefully casting the bait forward.
